(19) United States
(12) Patent Application Publication
(10) Pub. No.: US 2018/0364898 A1
(43) Pub. Date: Dec. 20, 2018

(54) Systems, Devices, and/or Methods for Managing Text Rendering

(71) Applicant: Zihan Chen, Charlottesville, VA (US)

(72) Inventor: Zihan Chen, Charlottesville, VA (US)

(21) Appl. No.: 15/623,198

(22) Filed: Jun. 14, 2017

(51) Int. Cl. G06F 3/0484; G06F 3/01; G06F 3/0346; G06F 17/21; G06F 3/0488

(52) U.S. Cl. CPC G06F 3/04847; G06F 3/016; G06F 3/04883; G06F 17/214; G06F 3/0346

(57) ABSTRACT

Certain exemplary embodiments can provide a method, which comprises causing a rendering of text on a user interface of an information device. The text comprises at least one element differentiated via an appearance change. A rate of the appearance change of the at least one element is determined by a predetermined preference of the at least one element. The text can be rendered with an overall degree of differentiation of elements, which overall degree of differentiation of elements is adjustable by the user.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 shows renderings of texts 1000 processed according to an exemplary embodiment;

FIG. 2 shows renderings of texts 2000 processed according to an exemplary embodiment;

FIG. 3 is a graph 3000;

FIG. 4 is a graph 4000;

FIG. 5 is a graph 5000;

FIG. 6 is a graph 6000;

FIG. 7 is a graph 7000;

FIG. 8 is a graph 8000;

FIG. 9 is a graph 9000;

FIG. 10 is a graph 10000;

FIG. 11 is a graph 11000;

FIG. 12 is a graph 12000;

FIG. 13 is a graph 13000;

FIG. 14 is a graph 14000;

FIG. 15 is a block diagram of an exemplary embodiment of a system 15000;

FIG. 16 is a block diagram of an exemplary embodiment of an information device 16000;

FIG. 17 is a flowchart of an exemplary embodiment of a method 17000;

FIG. 18 shows a pair of user interfaces 18000 according to an exemplary embodiment;

FIG. 19 shows three orientations of a user interface 19000 according to an exemplary embodiment;

FIG. 20 shows two sequential views of a user interface 20000 according to an exemplary embodiment; and

FIG. 21 shows two sequential views of a user interface 21000 according to an exemplary embodiment.

### DETAILED DESCRIPTION

Certain exemplary embodiments can provide a method, which comprises causing a rendering of text on a user interface of an information device. The text comprises at least one element differentiated via an appearance change. A rate of the appearance change of the at least one element is determined by a predetermined preference of the at least one element. The text can be rendered with an overall degree of differentiation of elements, which overall degree of differentiation of elements is adjustable by the user

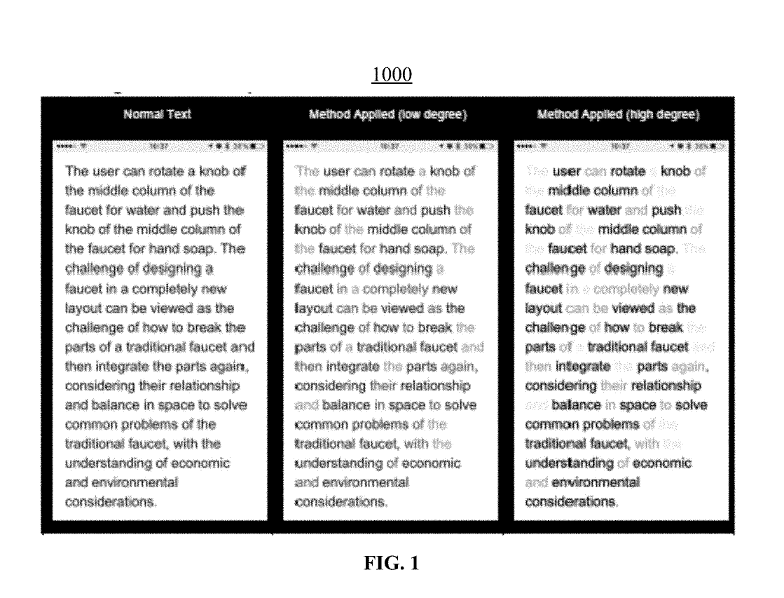

FIG. 1 shows renderings of texts 1000 processed according to an exemplary embodiment. The text shown on the left is rendered substantially normally. The text shown in the central column show some of the text differentiated in boldness. Some of the text also can have other difference such as different colors, and/or accentuated shadowing, etc. to further provide emphasis that allows further efficiency in user reading. The rightmost text shows a relatively high degree of differentiation such that words are differentiated to a greater degree than the central column. Such text rendering provides a user with a relatively efficient means of reading and understanding text.

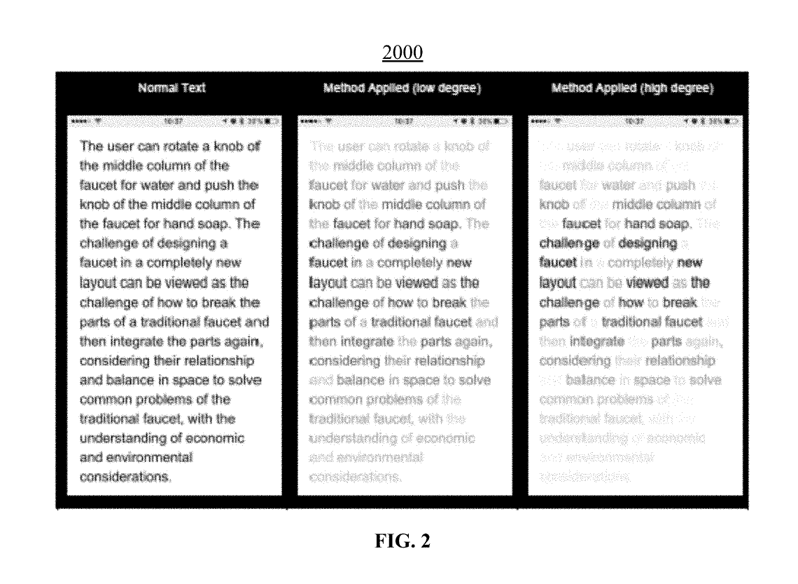

FIG. 2 shows renderings of texts 2000 processed according to an exemplary embodiment. The text shown on the left is rendered substantially normally. The text shown in the central column show some of the text differentiated in boldness. The text in middle of the text is shown as darker than text in the upper or lower portions of the central column. The rightmost text shows a relatively high degree of differentiation such that words are differentiated to a greater degree than the central column. Such text rendering provides a user with a relatively efficient means of reading and understanding text.

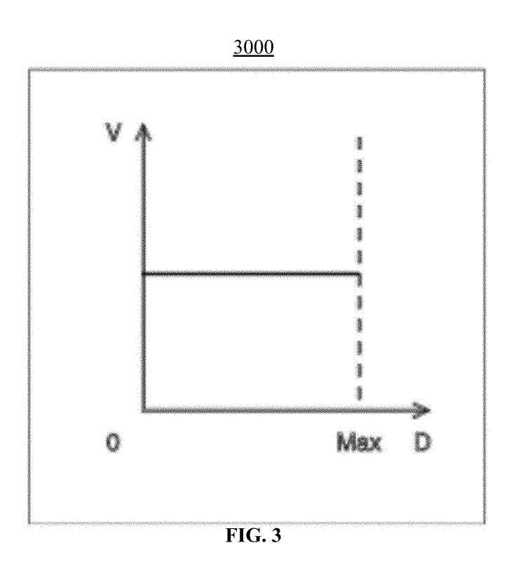

For all graphs shown in FIG. 3 to FIG. 14:
V, which is shown on the Y axis represents a degree of visualization of text elements on a certain visual aspect (for example: boldness, transparency, color, and/or line thickness, etc.); and
D, which is shown on the X axis represents a degree of control (for example: one or more of a user input, degree of pressure applied by the user, a duration of a touch of the user, and/or an angle of tilt of a device, etc.).

In certain exemplary embodiments, a user can choose a response according to any of FIG. 3 to FIG. 14 or any variation thereof to achieve a test display response that is preferred by the user.

FIG. 3 is a graph 3000, which is indicative of normal text presenting without any substantial variation in a visual aspect or a text element. Thus, substantially no visual aspect variation of text occurs regardless of how extensive a user action is. For example, if a user presses a button indicative of a desire to change text, substantially no change in the text occurs.

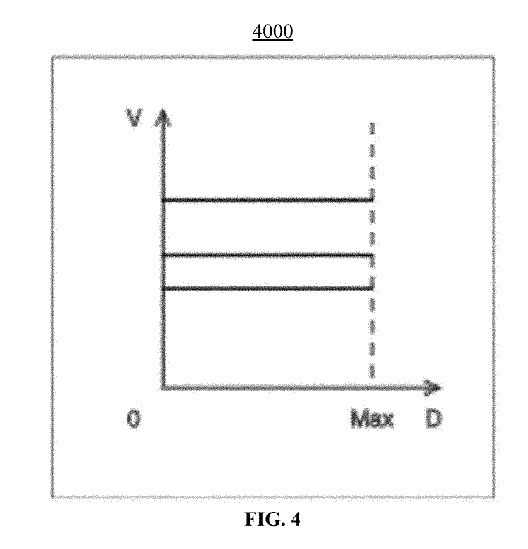

FIG. 4 is a graph 4000, which is indicative of normal text presenting with three groups of text elements being processed and the corresponding three levels of visualization but without any substantial visualization changes responsive to the degree of control asserted by the user. Text processing in accordance with graph 4000 allows three defined levels of visualization. Visualization levels can be different font sizes, different line thicknesses for text, color, and/or different text shadowing, etc.

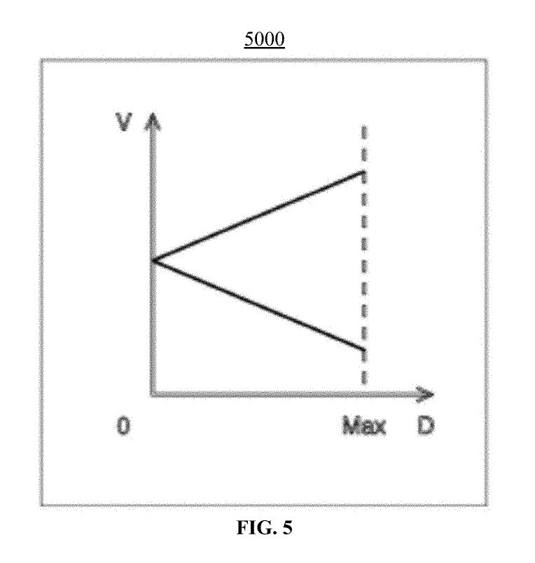

FIG. 5 is a graph 5000, which is indicative of text presenting and comprising:
two groups of text elements being processed;
visualization performed with a linear relationship to the degree of control.

In accordance with graph 5000, each of the two groups of text elements being processed is associated with the corresponding method of visualization. If visualization is performed in accordance with the upper line, visualization increases linearly in proportion with the user's actions concerning degree of control. If visualization is performed in accordance with the lower line, visualization decreases linearly in proportion with the user's actions concerning degree of control. For example, the user's action concerning degree of control can be a degree of pressure on a touch surface, an duration of a button push (e.g., a volume button on an electronic device), a degree of tilt of a device, and/or an extent to which a knob is rotated, etc.

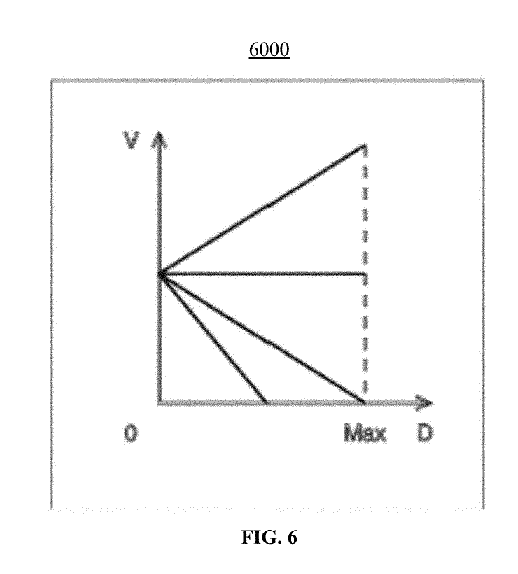

FIG. 6 is a graph 6000, which is indicative of text presenting with visualization, and comprising multiple (more than two) groups of text elements being processed and multiple (more than two) possible methods. In accordance with graph 6000, each of the four groups of text elements being processed is associated with the corresponding linear method of text visualization. If visualization is performed in accordance with the upper line, visualization increases linearly in proportion with the user's actions concerning degree of control. If visualization is performed in accordance with the substantially horizontal line on the graph, the text will be displayed substantially normally regardless of the user's actions concerning degree of control. If visualization is performed in accordance with the two lower lines, visualization decreases linearly in proportion with the user's actions concerning degree of control. For example, the user's action concerning degree of control can be a degree of pressure on a touch surface, an duration of a button push (e.g., a volume button on an electronic device), a degree of tilt of a device, and/or an extent to which a knob is rotated, etc.

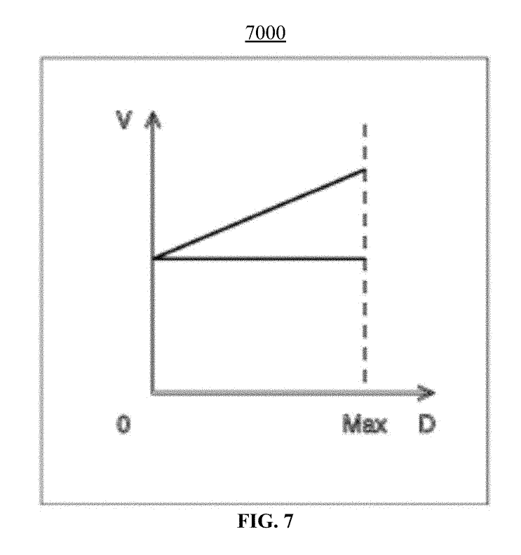

FIG. 7 is a graph 7000, which is indicative of text presenting with visualization, and comprising one or more some of the groups being substantially constant. In accordance with graph 7000, each of the two groups of text elements being processed is associated with the corresponding linear method of visualization. If visualization is performed in accordance with the upper line, visualization increases linearly in proportion with the user's actions concerning degree of control. If visualization is performed in accordance with the substantially horizontal line on the graph, the text will be displayed substantially normally regardless of the user's actions concerning degree of control.

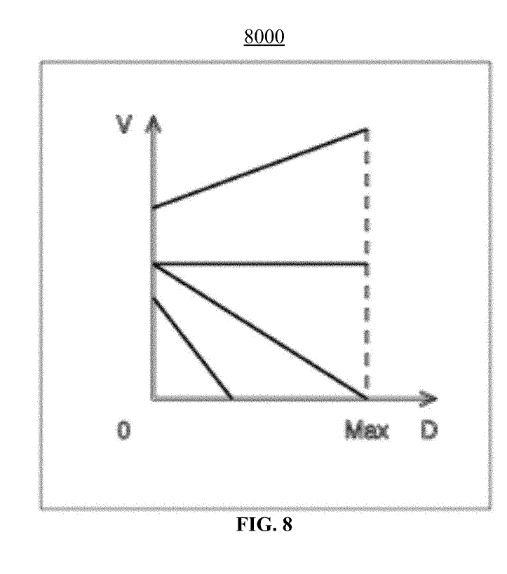

FIG. 8 is a graph 8000, which is indicative of text presenting with visualization, and comprising original levels of visualization of multiple groups that are not the same. In accordance with graph 8000, each of the four groups of text elements being processed is associated with the corresponding method of visualization. If visualization is performed in accordance with the upper line, visualization increases linearly in proportion with the user's actions concerning degree of control. If visualization is performed in accordance with the substantially horizontal line on the graph, the text will be displayed substantially normally regardless of the user's actions concerning degree of control. If visualization is performed in accordance with the two lower lines, visualization decreases linearly in proportion with the user's actions concerning degree of control. For example, the user's action concerning degree of control can be a degree of pressure on a touch surface, an duration of a button push (e.g., a volume button on an electronic device), a degree of tilt of a device, and/or an extent to which a knob is rotated, etc. Graph 8000 differs from graph 6000 in that the starting degrees of visualization of the four groups of text elements differ.

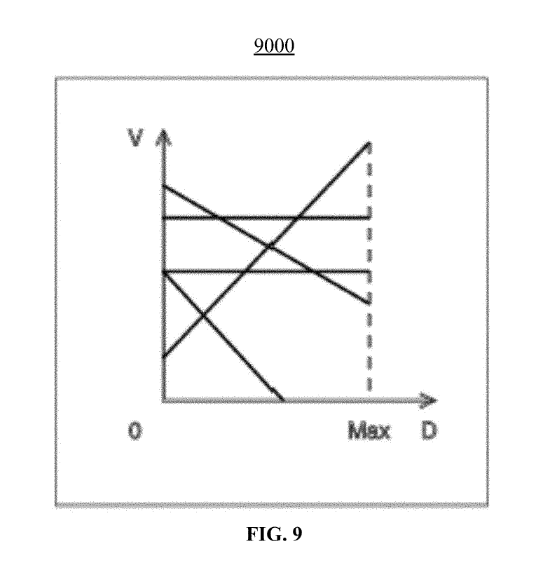

FIG. 9 is a graph 9000, which is indicative of text presenting with visualization, and comprising original levels of visualization of multiple groups that are not the same. In accordance with graph 9000, each of the five groups of text elements being processed is associated with the corresponding method of visualization. If visualization is performed in accordance with the upward sloping line, visualization increases linearly in proportion with the user's actions concerning degree of control. If visualization is performed in accordance with either of the two substantially horizontal lines on the graph, the text will be displayed substantially normally regardless of the user's actions concerning degree of control although with different degree of visualization depending upon which line is selected. If visualization is performed in accordance with the two downward sloping lines, visualization decreases linearly in proportion with the user's actions concerning degree of control (although with a different starting degree of differentiation depending upon which line is selected). For example, the user's action concerning degree of control can be a degree of pressure on a touch surface, an duration of a button push (e.g., a volume button on an electronic device), a degree of tilt of a device, and/or an extent to which a knob is rotated, etc.

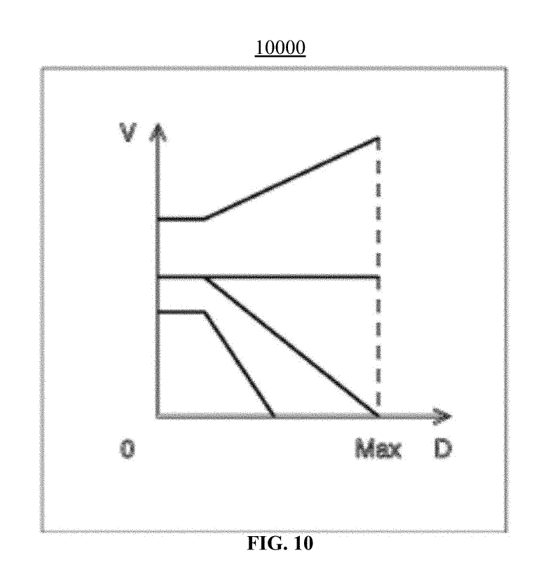

FIG. 10 is a graph 10000, which is indicative of text presenting with visualization, wherein some and/or all of the visualization changes are not starting at the very first degree of control. In accordance with graph 10000, each of the four groups of text elements being processed is associated with the corresponding method of visualization. If visualization is performed in accordance with the line with the upward sloping portion, visualization remains normal until a threshold is reached at which time the degree of visualization increases substantially linearly in proportion with the user's actions concerning degree of control. If visualization is performed in accordance with the substantially horizontal line on the graph, the text will be displayed substantially normally regardless of the user's actions concerning degree of control. If visualization is performed in accordance with the two lines with downward sloping portions, visualization remains normal until respective thresholds are reached at which time visualization decreases linearly in proportion with the user's actions concerning degree of control. For example, the user's action concerning degree of control can be a degree of pressure on a touch surface, an duration of a button push (e.g., a volume button on an electronic device), a degree of tilt of a device, and/or an extent to which a knob is rotated, etc.

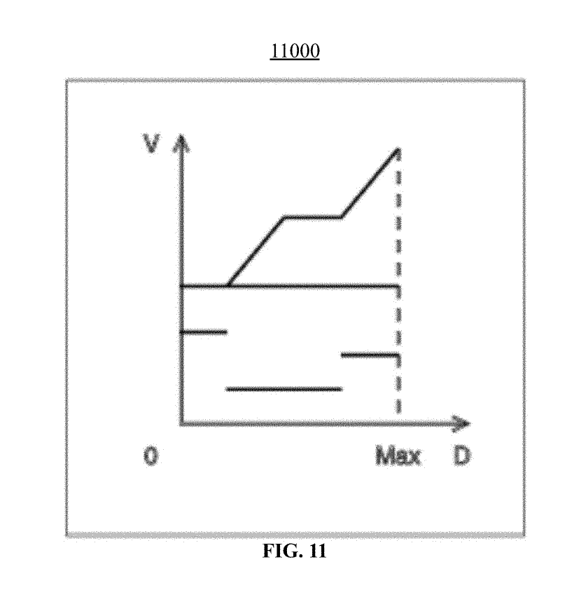

FIG. 11 is a graph 11000, which is indicative of text presenting with visualization, wherein visualization changes happen with a segmented relationship to a degree of control. In accordance with graph 11000, each of the three groups of text elements being processed is associated with the corresponding method of visualization. If visualization is performed in accordance with the line with upward sloping portions, visualization is static on the horizontal portions of the line and increases linearly in proportion with the user's actions concerning degree of control in upward sloping portions of the line. If visualization is performed in accordance with the substantially horizontal line on the graph, the text will be displayed substantially normally regardless of the user's actions concerning degree of control. If visualization is performed in accordance with the lower lines, visualization changes stepwise based upon the user's actions concerning degree of control. For example, the user's action concerning degree of control can be a degree of pressure on a touch surface, an duration of a button push (e.g., a volume button on an electronic device), a degree of tilt of a device, and/or an extent to which a knob is rotated, etc.

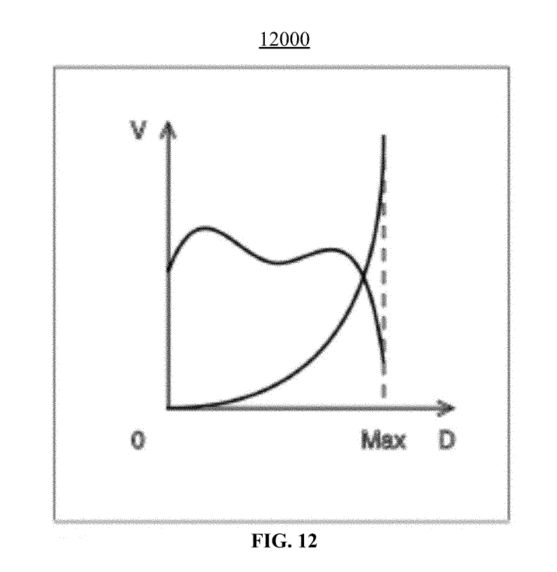

FIG. 12 is a graph 12000, which is indicative of text presenting with visualization, wherein some and/or all of the changes in visualization happen with a non-linear relationship to a degree of control. In accordance with graph 12000, each of the two groups of text elements being processed is associated with the corresponding method of visualization.

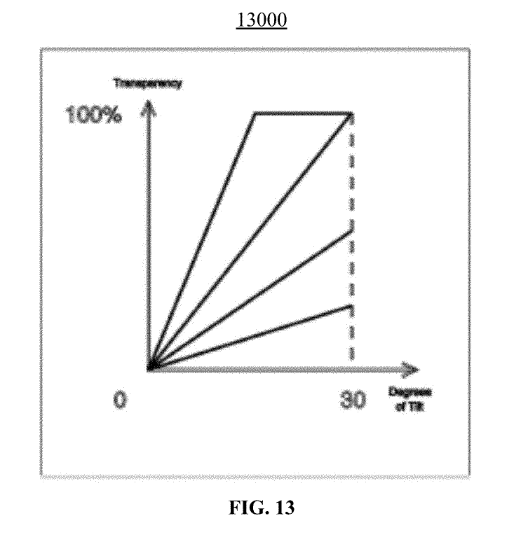

FIG. 13 is a graph 13000, which is indicative of text presenting with visualization changes, wherein: the characteristic of visualization of the text is transparency; and the degree of control is associated with degrees of tilt of a presenting device. In accordance with graph 13000, each of the four groups of text elements being processed is associated with the corresponding method of visualization.

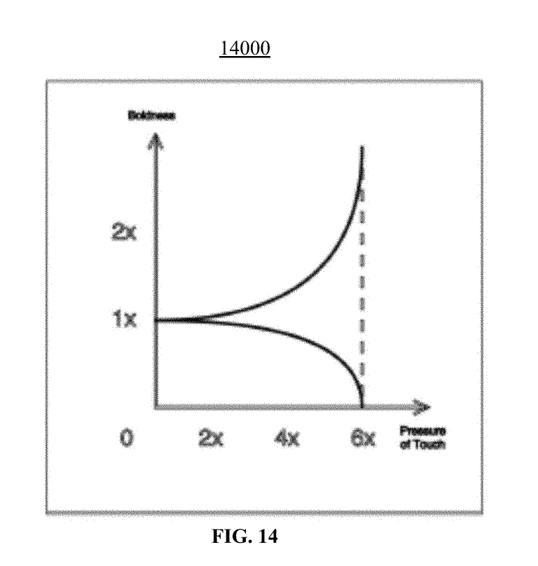

FIG. 14 is a graph 14000, which is indicative of text presenting with visualization, wherein the characteristic of visualization of the text is boldness; and the degree of control is associated with the pressure of a user touch on a user interface of an information device. In accordance with graph 14000, each of the two groups of text elements being processed is associated with the corresponding method of visualization.

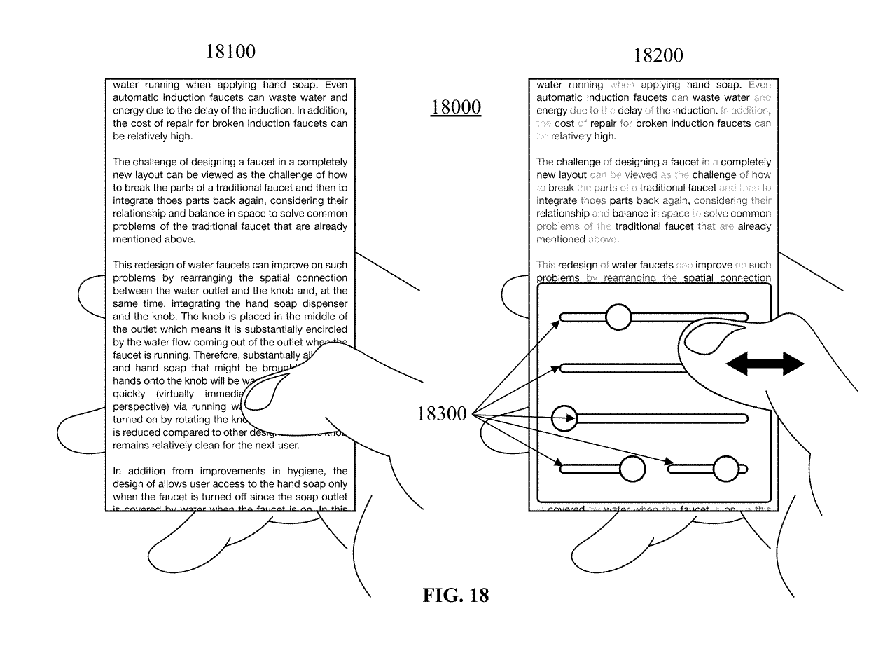

FIG. 18 shows a pair of user interfaces 18000 according to an exemplary embodiment. First user interface 18100 illustrates text displayed substantially without visualization changes or text differentiation and the overall degree of differentiation of each of the text elements in the text is zero. Second user interface 18200 illustrates a control panel via which the appearance of text can be changed in accordance with positions selected on one or more of the five illustrated slide selectors 18300 by changing the overall degree of differentiation of each of the text elements in the text. Each of the slide selectors is able to influence the appearance of text on second user interface 18200 by changing the overall degree of differentiation of each of the text elements in the text or changing the preference of the each or some of the text elements.

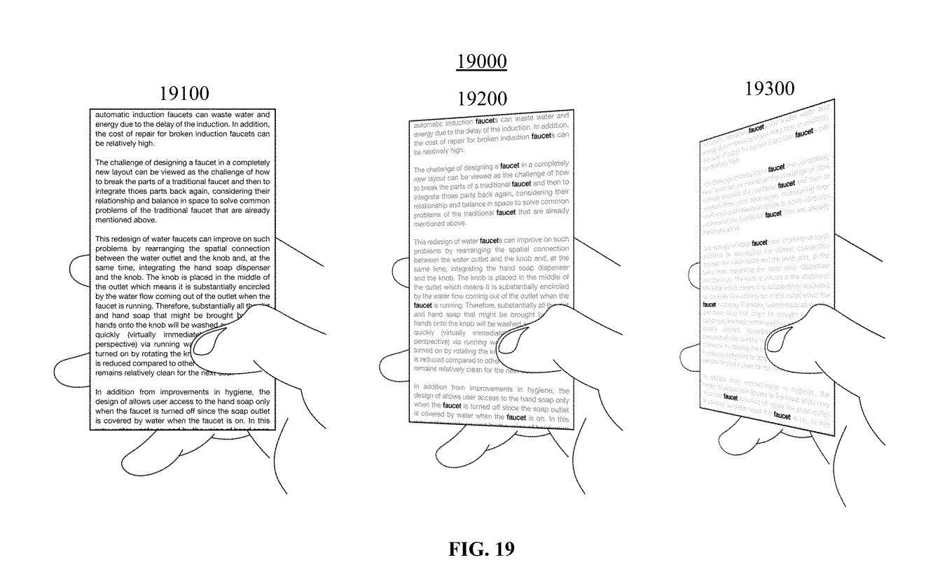

FIG. 19 shows three orientations of a user interface 19000 according to an exemplary embodiment. At first orientation 19100, the text is substantially uniform in appearance and the overall degree of differentiation of each of the text elements in the text is zero. As the user interface is rotated to second orientation 19200, the appearance of the text changes, which caused by the changing of the overall degree of differentiation of each of the text elements in the text, responsive to an automatically detected movement (e.g., rotation) of user interface 19000. As the user interface is rotated to third orientation 19300, the appearance of the text further changes, which caused by the changing of the overall degree of differentiation of each of the text elements in the text, responsive to an automatically detected movement of user interface 19000.

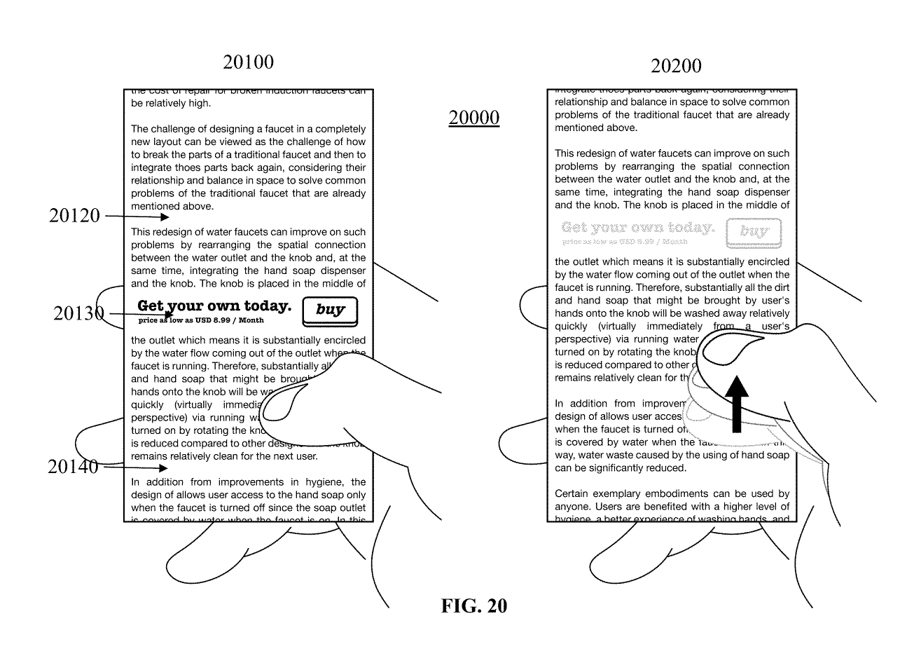

FIG. 20 shows two sequential views of a user interface 20000 according to an exemplary embodiment. First view 20100 shows text in a first section 20120, a second section 20130, and a third section 20140. The text in first section 20120 and third section 20140 have a substantially uniform appearance. Second section 20130 comprises an advertisement to purchase something, which is rendered in a distinctive set of fonts that draw attention to the purchase offer. In the illustrated embodiment, second section 20130 comprises a screen button that allows a user to accept the purchase offer. The advertisement in the second section 20130, which is one text element within the whole text, is rendered at its originality without being differentiated. In second view 20200, the advertisement in the second section 20130 is greyed out, which caused by the changing of the overall degree of differentiation of each of the text elements in the text, responsive to an automatically detected user gesture of scrolling on the user interface. How much the advertisement is greyed out, which caused by the changing of the overall degree of differentiation of each of the text elements in the text, can be associated with the speed of the user gesture of scrolling on the user interface.

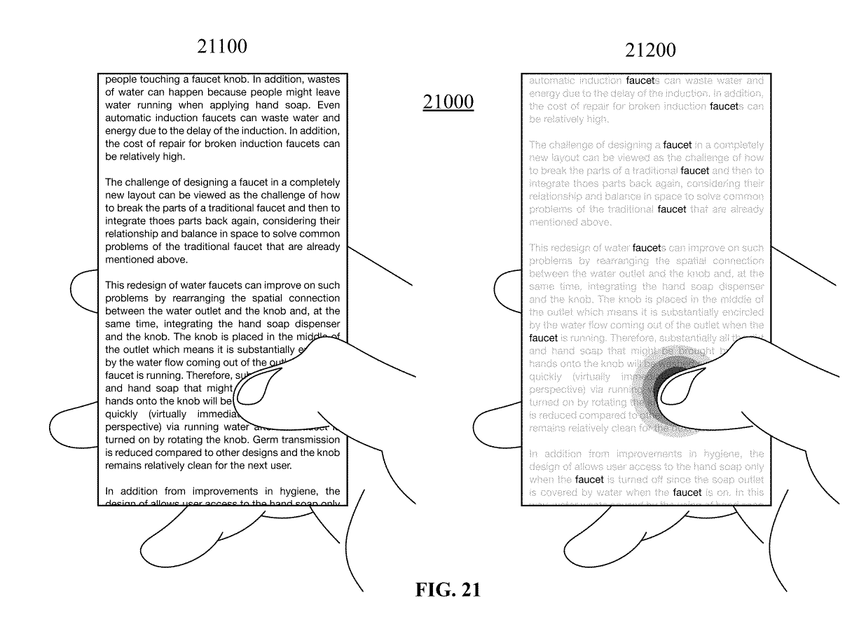

FIG. 21 shows two sequential views of a user interface 21000 according to an exemplary embodiment. First view 21100 shows text having a substantially uniform appearance and the overall degree of differentiation of each of the text elements in the text is zero. Second view 21200 shows text having some words that are differentiated from others based on the searched term a user entered. In the illustrated embodiment, the word faucet is emphasized, responsive to an automatically detected change of pressure acted on the user interface. In other embodiments, a word such as faucet can be emphasized, responsive to an automatically detected change of biometric inputs on the user interface. In other embodiments, other words can be emphasized via various automated criteria and/or user selections.

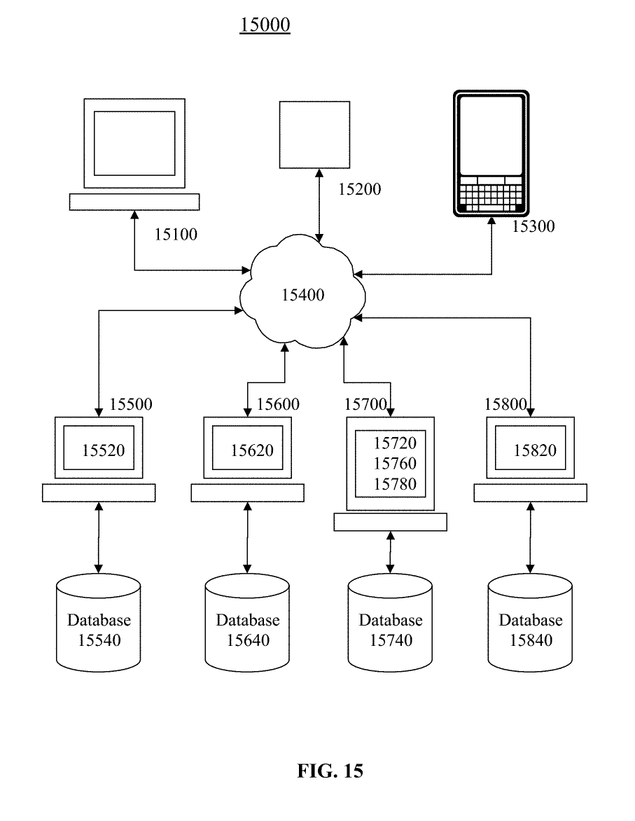

FIG. 15 is a block diagram of an exemplary embodiment of a system 15000, which can comprise a smartphone 15300, an information device 15100, tablet 15200, a network 15400, a first server 15500, a second server 15600, a third server 15700, and a fourth server 15800. First server 15500 can comprise a first user interface 15520 and can be coupled to a first database 15540. Second server 15600 can comprise a second user interface 15620 and can be coupled to a second database 15640. Third server 15700 can comprise a third user interface 15720, a processor 15760, machine instructions 15780, and can be coupled to a third database 15740. Fourth server 15800 can comprise a fourth user interface 15820 and can be coupled to a fourth database 15840. Any of the methods and/or steps thereof can be carried out in whole or in part by tablet 15200, smartphone 15300, information device 15100 and/or first server 15500. Second server 15600, third server 15700, and/or fourth server 15800 can each be associated with implementation of a system via which text processing is provided in accordance with exemplary embodiments disclosed herein. In certain exemplary embodiments, system 15000 can be used to implement one or more methods disclosed herein.

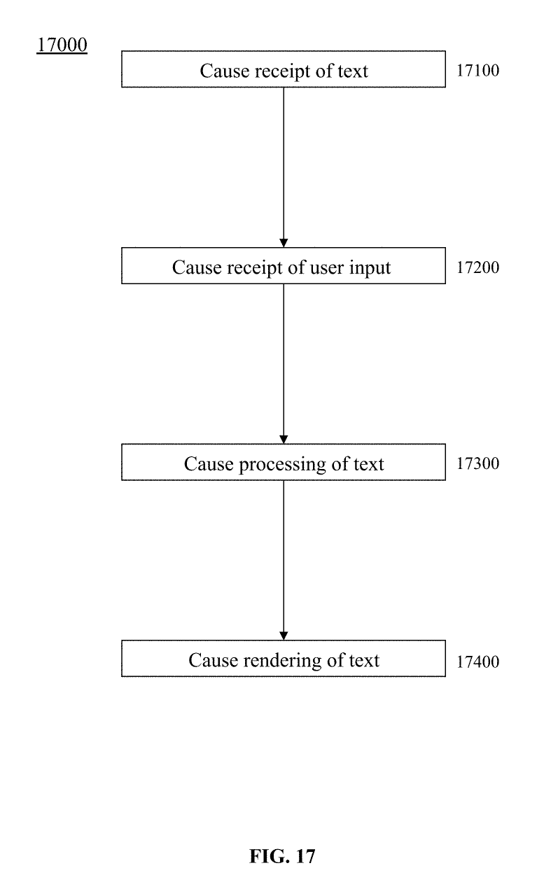

FIG. 17 is a flowchart of an exemplary embodiment of a method 17000. At activity 17100, certain exemplary embodiments can cause text to be received at an information device. At activity 17200, certain exemplary embodiments can cause receipt of a user input. At activity 17300, certain exemplary embodiments can cause a processing of the text responsive to the user input.

At activity 17400, certain exemplary embodiments can cause a rendering of the processed text. Certain exemplary embodiments can cause a rendering of text on a user interface of an information device, the text comprising at least one element differentiated via an appearance change. A rate of the appearance change of the at least one element can be determined by a predetermined preference of the at least one element. The text can be rendered with an overall degree of differentiation of elements. The overall degree of differentiation of elements can be adjustable by the user.

The overall degree of differentiation of elements can be adjusted by a detected act on a physical object. The physical object can be communicatively coupled to the information device or on the information device. The detected act can be at least one of pressing a button, pressing a key on a keyboard, and/or moving a control wheel, etc. The overall degree of differentiation of elements can be adjusted by a detected act on a physical object. The physical object can be communicatively coupled to the information device or on the information device. The detected act can:
comprise contacting a touch sensitive surface;
be via a haptic sensor;
be via one or more of a controlling pad, a remote control, a mouse, and a drawing pad;
comprise tilting a tilt sensor;
comprise vibrating a vibration sensor;
comprise changing a pressure on a surface;
comprise rotating a rotation sensor;
comprise accelerating an acceleration sensor; and/or
comprise at least one of deforming or transforming a flexible, foldable, stretchable surface, or elastic device, etc.

The overall degree of differentiation of elements can be adjusted responsive to a physical environment that comprises one or more of:
a brightness;
a volume of sound;
a temperature; and/or
a humidity, etc.

The overall degree of differentiation of elements is adjusted based on a user input that comprises one or more of:
a gesture of the user input applied on the user interface;
a speed of the user input applied on the user interface;
a location of the user input applied on the user interface;
a the biometric identification of the user input applied on the user interface; and/or
a duration of the user input applied on the user interface, etc.

The at least one element can comprise one or more of the following:
a letter;
a number;
a symbol;
a word;
a set of words;
a syllable;
a set of syllables;
a character;
a set of characters;
a line of words rendered via the user interface;
more than one line of words;
a rendered paragraph;
more than one rendered paragraph;
a sentence; and/or
more than one sentence, etc.

The preference of the at least one element can be determined based on one or more of the following:
a type of the at least one element;
a frequency of the at least one element in the text;
a relevance of the at least one element to a search term;
a relevance of the at least one element to an element in a provided library;
a structural location of the at least one element in the text;
a first distance in between the at least one element and a predetermined location on the user interface;
a second distance in between the at least one element and a determined location geographically in space; and/or
a third distance in between the at least one element and an edge of the user interface, etc.

The text can be rendered in multiple ways based on different methods of overall degree of differentiation.

Certain exemplary embodiments can cause a change of rendering of each of a plurality of text elements on a user interface of an information device. A rate of an appearance change of each of the text elements can be determined by a predetermined preference of the each of the text elements. The text can be rendered with an overall degree of differentiation of each of the text elements. The overall degree of differentiation of each of the text elements can be adjustable by the user.

Certain exemplary embodiments can cause a change of rendering of each of a plurality of text elements on a user interface of an information device. A rate of an appearance change of each of the text elements can be determined by a predetermined preference of the each of the text elements.

The text element can comprise one or more of the following:
a letter;
a number;
a symbol;
a word;
a set of words;
a syllable;
a set of syllables;
a character;
a set of characters;
a line of words rendered via the user interface;
more than one line of words;
a rendered paragraph;
more than one rendered paragraph;
a sentence; and/or
more than one sentence, etc.

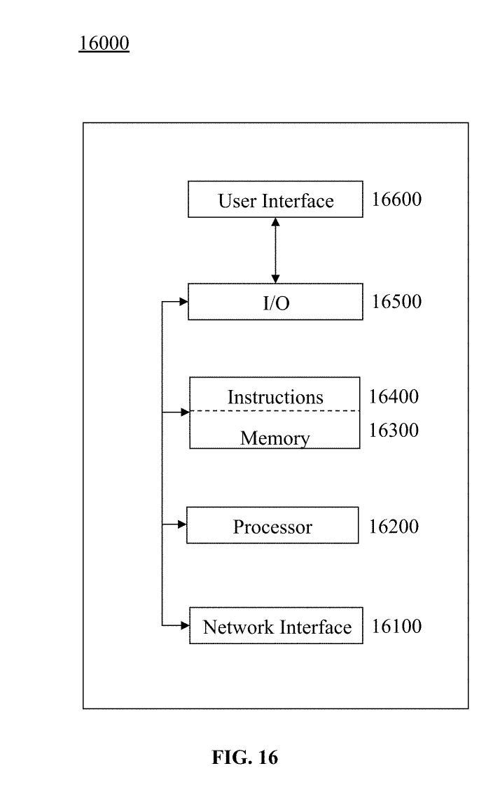

FIG. 16 is a block diagram of an exemplary embodiment of an information device 16000, which in certain operative embodiments can comprise, for example, tablet 15200, first server 15500, and/or information device 15100 of FIG. 15. Information device 16000 can comprise any of numerous circuits and/or components, such as for example, one or more network interfaces 16100, one or more processors 16200, one or more memories 16300 containing instructions 16400, one or more input/output (I/O) devices 16500, and/or one or more user interfaces 16600 coupled to one or more input/output (I/O) devices 16500, etc.

In certain exemplary embodiments, via one or more user interfaces 16600, such as a graphical user interface, a user can view a rendering of information related to rendering text in accordance with devices, systems, and/or methods disclosed herein.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
adjust—to change something.
and/or—either in conjunction with or in alternative to.
apparatus—an appliance or device for a particular purpose.
appearance change—a rendered difference in text compared to other text via one or more text transparency, color, size, boldness, surrounding area, and/or contrast to a background of the text, etc.
associate—to join, connect together, and/or relate.
automatically—acting or operating in a manner essentially independent of external influence or control. For example, an automatic light switch can turn on upon “seeing” a person in its view, without the person manually operating the light switch.
brightness—luminance of a body.
button—a physical or graphical control element that provides a user, via touch, a means for triggering an event, such as searching for a query at a search engine, interacting with dialog boxes, and/or confirming an action, etc.
can—is capable of, in at least some embodiments.
calculation—a deliberate process that transforms one or more inputs into one or more results.
cause—to produce an effect.
circuit—an electrically conductive pathway and/or a communications connection established across two or more switching devices comprised by a network and between corresponding end systems connected to, but not comprised by the network.
comprising—including but not limited to.
configure—to make suitable or fit for a specific use or situation.
constructed to—made to and/or designed to.
control wheel—a rotatable object coupled to an information device.
convert—to transform, adapt, and/or change.
couple—to link in some fashion.
create—to bring into being.
data—distinct pieces of information, usually formatted in a special or predetermined way and/or organized to express concepts.
data structure—an organization of a collection of data that allows the data to be manipulated effectively and/or a logical relationship among data elements that is designed to support specific data manipulation functions. A data structure can comprise meta data to describe the properties of the data structure. Examples of data structures can include: array, dictionary, graph, hash, heap, linked list, matrix, object, queue, ring, stack, tree, and/or vector.
define—to establish the outline, form, or structure of
degree—an extent or magnitude.
detect—to sense.
detected movement—a sensed change of a property or location of an object.
determine—to obtain, calculate, decide, deduce, and/or ascertain.
device—a machine, manufacture, and/or collection thereof.
differentiate—to distinguish in some way compared to something else.
distance—an amount of space between two things.
element—one or more characters, letters, numbers, symbols, emojis, and/or images rendered via a user interface.
estimate—to calculate and/or determine approximately and/or tentatively.
frequency—how often something occurs.
generate—to create, produce, give rise to, and/or bring into existence.
gesture—a body movement (e.g., swiping, scrolling or tapping).
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a Virtual Reality device, an Augmented Reality device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
importance—significance, relevance, and/or usefulness.
initialize—to prepare something for use and/or some future event.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
key—a button on a keyboard.
keyboard—a set of buttons on an object that is coupleable to an information device.
line—a row of rendered letters, characters, and/or words, etc.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
movement—a change of a property or location of an object detected via gravity and/or a gyro sensor, etc.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
overall degree of differentiation—an extent of how much modified text differs from original text. For example, if an overall degree of differentiation is zero then modified text is presented as having a same appearance of the original text; however, if the degree of differentiation is higher, then some of the least important text elements may substantially disappear.
packet—a discrete instance of communication.
paragraph—a distinct portion of written or printed matter dealing with a particular idea, usually beginning with an indentation on a new line.
physical gesture—a movement of a user. For example, a physical gesture can be a tap or swipe of a portion of the user interface.
physical object—a thing that can be dependent or independent of a user interface.
plurality—the state of being plural and/or more than one.
predetermined—established in advance.
probability—a quantitative representation of a likelihood of an occurrence.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
project—to calculate, estimate, or predict.
provide—to furnish, supply, give, and/or make available.
provided library—a database communicatively coupled to an information device.
receive—to get as a signal, take, acquire, and/or obtain.
recommend—to suggest, praise, commend, and/or endorse.
relevance—a condition of being connected with something.
remote control—a component communicatively coupleable to an electronic device used to operate the electronic device wirelessly from a distance.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
request—to express a desire for and/or ask for.
search term—a word or combination of words or characters entered into an information device in order to specify a particular thing to be sought for on the World Wide Web, over a computer network, and/or in a database, etc.
select—to make a choice or selection from alternatives.
sentence—a grammatical unit of one or more words that expresses an independent statement, question, request, command, and/or exclamation, etc.
set—a related plurality.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asychronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
store—to place, hold, and/or retain data, typically in a memory.
structural location—a physical position of an element rendered via a user interface. For example, a structural location can be a title, a position in a sentence, and/or an indentation, etc.
substantially—to a great extent or degree.
surrounding area—a region in proximity to an element, such as a padding of the element.
syllable—a segment of speech consisting of a vowel sound, a diphthong, or a syllabic consonant, with or without preceding or following consonant sounds.
system—a collection of mechanisms, devices, machines, articles of manufacture, processes, data, and/or instructions, the collection designed to perform one or more specific functions.
text—characters, words, syllabus, sentences, paragraphs, punctuation symbols, symbols, numbers, emojis, and/or images rendered via a user interface.
touch sensitive surface—a sensor that detects a touch from a finger or other surface and causes a response.
transmit—to send as a signal, provide, furnish, and/or supply.
type—a category into which an element can be placed. For example, a type of a word can be a noun or verb.
user—a human that utilizes something.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.
visual strength—intensity observable by a human.
voice command—an audible utterance of a human that causes a response.
weight—a value indicative of importance.
word—a unit of language, consisting of one or more spoken sounds or their written representation, that functions as a carrier of meaning.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising:
causing a rendering of text on a user interface of an information device, the text comprising at least one element differentiated via an appearance change, a rate of the appearance change of the at least one element determined by a predetermined preference of the at least one element, wherein the text is rendered with an overall degree of differentiation of elements, the overall degree of differentiation of elements adjustable by the user.

2. The method of claim 1, wherein:
the overall degree of differentiation of elements is adjusted by a detected act on a physical object, the physical object communicatively coupled to the information device or on the information device, wherein the detected act is at least one of pressing a button, pressing a key on a keyboard, and moving a control wheel.

3. The method of claim 1, wherein:
the overall degree of differentiation of elements is adjusted by a detected act on a physical object, the physical object communicatively coupled to the information device or on the information device, wherein the detected act comprises contacting a touch sensitive surface.

4. The method of claim 1, wherein:
the overall degree of differentiation of elements is adjusted by a detected act on a physical object, the physical object communicatively coupled to the information device or on the information device, wherein the detected act is via a haptic sensor.

5. The method of claim 1, wherein:
the overall degree of differentiation of elements is adjusted by a detected act on a physical object, the physical object communicatively coupled to the information device or on the information device, wherein the detected act is via one or more of a controlling pad, a remote control, a mouse, and a drawing pad.

6. The method of claim 1, wherein:
the overall degree of differentiation of elements is adjusted by a detected act on a physical object, the physical object communicatively coupled to the information device or on the information device, wherein the detected act comprises tilting a tilt sensor.

7. The method of claim 1, wherein:
the overall degree of differentiation of elements is adjusted by a detected act on a physical object, the physical object communicatively coupled to the information device or on the information device, wherein the detected act comprises vibrating a vibration sensor.

8. The method of claim 1, wherein:
the overall degree of differentiation of elements is adjusted by a detected act on a physical object, the physical object communicatively coupled to the information device or on the information device, wherein the detected act comprises changing a pressure on a surface.

9. The method of claim 1, wherein:
the overall degree of differentiation of elements is adjusted by a detected act on a physical object, the physical object communicatively coupled to the information device or on the information device, wherein the detected act comprises rotating a rotation sensor.

10. The method of claim 1, wherein:
the overall degree of differentiation of elements is adjusted by a detected act on a physical object that is communicatively coupled to the information device or on the information device, wherein the detected act comprises accelerating an acceleration sensor.

11. The method of claim 1, wherein:
the overall degree of differentiation of elements is adjusted by a detected act on a physical object, the physical object communicatively coupled to the information device or on the information device, wherein the detected act comprises at least one of deforming or transforming a flexible, foldable, stretchable surface, or elastic device.

12. The method of claim 1, wherein:
the overall degree of differentiation of elements is adjusted responsive to a physical environment that comprises one or more of:
a brightness;
a volume of sound;
a temperature; and
a humidity.

13. The method of claim 1, wherein:
the overall degree of differentiation of elements is adjusted based on a user input that comprises one or more of:
a gesture of the user input applied on the user interface;
a speed of the user input applied on the user interface;
a location of the user input applied on the user interface;
a the biometric identification of the user input applied on the user interface; and
a duration of the user input applied on the user interface.

14. The method of claim 1, wherein:
the at least one element comprises one or more of the following:
a letter;
a number;
a symbol;
a word;
a set of words;
a syllable;
a set of syllables;
a character;
a set of characters;
a line of words rendered via the user interface;
more than one line of words;
a rendered paragraph;
more than one rendered paragraph;
a sentence; and
more than one sentence.

15. The method of claim 1, wherein:
the preference of the at least one element is determined based on one or more of the following:
a type of the at least one element;
a frequency of the at least one element in the text;
a relevance of the at least one element to a search term;
a relevance of the at least one element to an element in a provided library;
a structural location of the at least one element in the text;
a first distance in between the at least one element and a predetermined location on the user interface;
a second distance in between the at least one element and a determined location geographically in space; and
a third distance in between the at least one element and an edge of the user interface.

16. The method of claim 1, wherein:
the text can be rendered in multiple ways based on different methods of overall degree of differentiation.

17. A method of text rendering comprising:
causing a change of rendering of each of a plurality of text elements on a user interface of an information device, a rate of an appearance change of each of the text elements determined by a predetermined preference of the each of the text elements, wherein the text is rendered with an overall degree of differentiation of each of the text elements, the overall degree of differentiation of each of the text elements adjustable by the user.

18. The method of claim 17, wherein:
the text element comprises one or more of the following:
a letter;
a number;
a symbol;
a word;
a set of words;
a syllable;
a set of syllables;
a character;
a set of characters;
a line of words rendered via the user interface;
more than one line of words;
a rendered paragraph;
more than one rendered paragraph;
a sentence; and
more than one sentence.

19. A method of text rendering comprising:
causing a change of rendering of each of a plurality of text elements on a user interface of an information device, a rate of an appearance change of each of the text elements determined by a predetermined preference of the each of the text elements.

20. The method of claim 19, wherein:
the text element comprises one or more of the following:
a letter;
a number;
a symbol;
a word;
a set of words;
a syllable;
a set of syllables;
a character;
a set of characters;
a line of words rendered via the user interface;
more than one line of words;
a rendered paragraph;
more than one rendered paragraph;
a sentence; and
more than one sentence.
